(19) United States
(12) Patent Application Publication
(10) Pub. No.: US 2012/0154969 A1
(43) Pub. Date: Jun. 21, 2012

(54) OVERCURRENT DETECTION CIRCUIT OF LIGHT EMITTING MODULE

(75) Inventors: Jin Hwan KIM, Osan (KR); Young Su JANG, Seoul (KR); Heung Gyoon CHOI, Suwon (KR); Sung Ho KIM, Hwaseong (KR)

(73) Assignee: SAMSUNG ELECTRO-MECHANICS CO., LTD., Gyunggi-do (KR)

(21) Appl. No.: 13/085,534

(22) Filed: Apr. 13, 2011

(30) Foreign Application Priority Data
Dec. 21, 2010 (KR) 10-2010-0131866

(51) Int. Cl. H02H 9/02

(52) U.S. Cl. 361/93.9

(57) ABSTRACT

There is provided an overcurrent detection circuit of a light emitting module, including: a clamping circuit unit 100 detecting a detection voltage Vd from a detection connection node Nd connected to a cathode terminal NC of a light emitting module 50 including at least one light emitting element and clamping the detection voltage Vd to a preset clamping voltage VCL; and an abnormality detection unit 200 determining a voltage V10 clamped by the clamping circuit unit 100 to be overcurrent and generating an overcurrent detection signal, when the voltage clamped by the clamping circuit unit is lower than a preset first reference voltage VREF1.

### CROSS-REFERENCE TO RELATED APPLICATIONS

This application claims the priority of Korean Patent Application No. 10-2010-0131866 filed on Dec. 21, 2010, in the Korean Intellectual Property Office, the disclosure of which is incorporated herein by reference.

### BACKGROUND OF THE INVENTION

1. Field of the Invention

The present invention relates to an overcurrent detection circuit of a light emitting device capable of detecting overcurrent due to abnormal operating conditions in a light emitting module that may be applied to a TV or a display.

2. Description of the Related Art

Generally, with the increase in interest in an LED-TV using a light emitting diode (LED) as a light source, research into a LED module used as a backlight light source has been also variously conducted. Accordingly, a driver circuit driving the LED module has been also variously researched and developed.

Generally, an LED has more advantages as compared to an existing cold cathode fluorescent, lamp (CCFL) or the like but also has disadvantages in that an electrical open or short may occur as a thickness of a device to which the LED is applied, such as a TV or the like, is thinned. Owing to these disadvantages, an appropriate protection circuit is required for the driving of a power circuit.

The LED module is configured by connecting a plurality of LEDs in series between anode terminals and cathode terminals according to the size of a screen of a display device such as a TV or the like. A driving power supplying unit of the LED module supplies appropriate power to the LED module using a converter (for example, a boost, a buck, an LLC or the like) and in particular, has a function of controlling constant current for brightness uniformity.

Meanwhile, a problem may arise in which any one portion of the plurality of LEDs connected in series shorts with the chassis of a TV set or a metal, forming a printed circuit board (PCB) of the LED, due to defects in the LED module or problems in a manufacturing process thereof, in particularly, as a thickness of the TV set using the LEDs is gradually thinly manufactured.

Therefore, the cathode terminal may electrically short with the chassis corresponding to a ground potential to allow overcurrent to flow in the LED module, thereby causing serious problems such as breakage of the LED and breakage of a panel due to overheating of the LED, or the like.

### SUMMARY OF THE INVENTION

An aspect of the present invention is to provide an overcurrent detection circuit of a light emitting module capable of detecting overcurrent caused due to abnormal operating conditions such as circuit board and chassis shorts or the like in the light emitting module that may be applied to a television or display.

According to an aspect of the present invention, there is provided an overcurrent detection circuit of a light emitting module, the overcurrent detection circuit including a clamping circuit unit detecting a detection voltage from a detection connection node connected to a cathode terminal of a light emitting module including at least one light emitting element and clamping the detection voltage to a preset clamping voltage; and an abnormality detection unit determining the voltage clamped by the clamping circuit unit to be overcurrent and generating an overcurrent detection signal when the voltage clamped by the clamping circuit unit is lower than a preset first reference voltage.

The clamping circuit unit may be connected to the detection connection node between the cathode terminal of the light emitting module and a switch for controlling current flowing in the light emitting module.

The clamping circuit unit may output voltage having a lower level than that of the first reference voltage to the abnormality detection unit when the detection voltage of the detection connection node is lower than the preset clamping voltage, and may output the clamping voltage having a higher level than the first reference voltage to the abnormality detection unit when the detection voltage of the detection connection node is higher than the preset clamping voltage.

The abnormality detection unit may include: a first detection unit detecting whether or not an abnormality is present by comparing the voltage clamped by the clamping circuit unit with the first reference voltage; a current source connected to a power source terminal supplied with preset power source voltage; a first switch connected between the current source and a ground and performing a switching operation according to an output signal of the first detection unit; a capacitor connected between a charging connection node provided between the current source and the first switch and the ground; a second detection unit detecting whether or not an abnormality is present, maintained for a preset predetermined time by comparing the voltage charged in the capacitor with a preset second reference voltage; and a second switch connected between an output node provided between an output resistor connected to the power source terminal and an output terminal and the ground and performing a switching operation according to an output signal of the second detection unit to output an overcurrent detection signal to the output terminal.

The clamping circuit unit may include an nMOSFET including a drain connected to the detection connection node, a source connected to an input terminal of the abnormality detection unit, and a gate connected to a clamping voltage terminal supplied with the clamping voltage.

The first detection unit may include a first operational amplifier including an inverting input terminal receiving the voltage clamped by the clamping circuit unit, an non-inverting input terminal receiving the first reference voltage, and an output terminal outputting a low level voltage when the clamped voltage is higher than the first reference voltage and outputting a high level voltage when the clamped voltage is lower than the first reference voltage.

The first detection unit may further include a inverter inverting a level of the output voltage from the first operational amplifier and outputting the inverted output voltage.

The second detection unit may include a second operational amplifier including a non-inverting input terminal receiving the voltage charged in the capacitor, an inverting input terminal receiving the second reference voltage, and an output terminal outputting the low level voltage when the charged voltage is lower than the second reference voltage and outputting the high level voltage when the charged voltage is higher than the second reference voltage.

The second detection unit may further include includes a second inverter inverting a level of the output voltage from the second operational amplifier and outputting the inverted output voltage.

The first switch may include an nMOSFET that is turned on to connect the charging connection node with the ground when the output signal of the first detection unit is at a high level, and is turned off to separate the charging connection node from the ground when the output signal of the first detection unit is at a low level.

The second switch may includes an nMOSFET that is turned on to connect the output node with the ground when the output signal of the second detection unit is at a high level, and is turned off to separate the output node from the ground when the output signal of the second detection unit is at a low level.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of an overcurrent detection circuit of a light emitting module according to an exemplary embodiment of the present invention;

FIG. 2 shows an example of a clamping circuit unit according to the exemplary embodiment of the present invention;

FIG. 3 shows an example of a first detection unit according to the exemplary embodiment of the present invention;

FIG. 4 shows an example of a second detection unit according to the exemplary embodiment of the present invention; and

FIG. 5 is a timing chart showing main operations according to the exemplary embodiment of the present invention.

### DETAILED DESCRIPTION OF THE PREFERRED EMBODIMENT

Exemplary embodiments of the present invention will now be described in detail with reference to the accompanying drawings.

The present invention should not be limited to the embodiments set forth herein and the embodiments may be used to assist in understanding the technical idea of the present invention. Like reference numerals designate like components having substantially the same constitution and function in the drawings of the present invention.

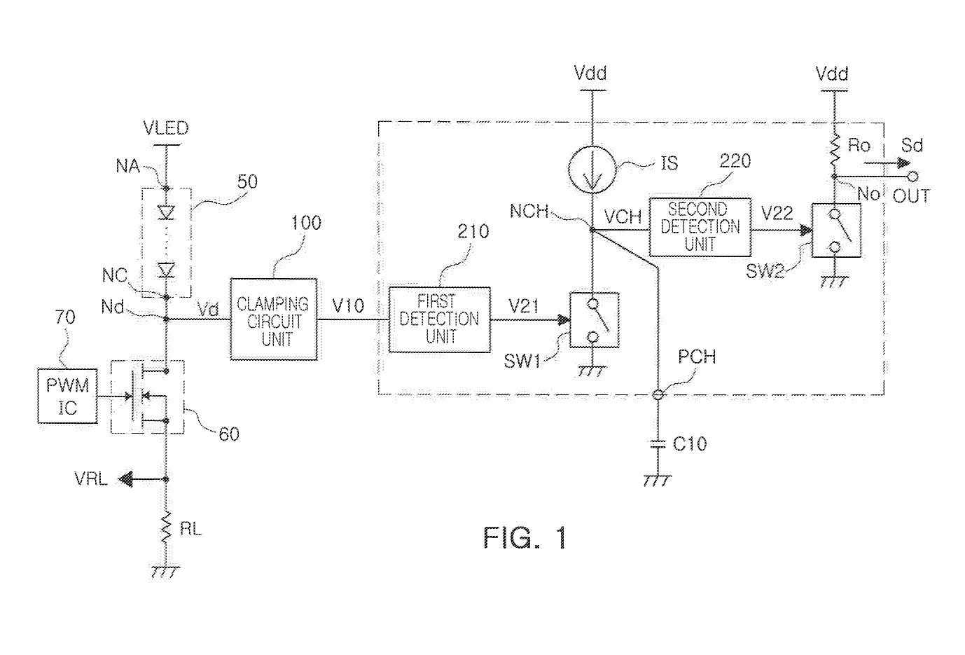

FIG. 1 is a configuration diagram of an overcurrent detention circuit of a light emitting module according to an exemplary embodiment of the present invention.

Referring to FIG. 1, an overcurrent detection circuit of a light emitting module according to an exemplary embodiment of the present invention may include a damning circuit unit 100 detecting a detection voltage Vd from a detection connection node Nd connected to a cathode terminal NC of a light emitting module 50 including at least one light emitting element and clamping the detection voltage Vd to a preset clamping voltage VCL.

In addition, the overcurrent detection unit of the light emitting module may include an abnormality detection unit 200. The abnormality detection unit 200 may determine a voltage V10 to be overcurrent and generate an overcurrent detection signal, when the voltage V10 clamped by the clamping circuit unit 100 is lower than a preset first reference voltage VREF1.

Herein, the light emitting module 50 may include a plurality of LEDs connected in series, in parallel, or in series-parallel.

Referring to FIG. 1, the clamping circuit unit 100 may be configured to be connected to the detection connection node Nd between the cathode terminal NC of the light emitting module 50 and a switch 60 for controlling current flowing in the light emitting module 50 in this case, the switch 60 may, for example, be configured in such a manner as to be operated in a PWM mode according to the control of a PWM IC 70.

More specifically, the clamping circuit unit 100 may output voltage having a lower level than that of the first reference voltage to the abnormality detection unit 200 when the detection voltage Vd of the detection connection node Nd is lower than the preset clamping voltage VCL, and output the clamping voltage VCL having a higher level than that of the first reference voltage to the abnormality detection unit 200 when the detection voltage Vd of the detection connection node Nd is higher than the preset clamping voltage VCL.

In addition, an example of the abnormality detection unit 200 will be described with reference to FIG. 1.

Referring to FIG. 1, the abnormality detection unit 200 may include a first detection unit 210 detecting whether or not an abnormality is present by comparing the voltage V10 clamped by the clamping circuit unit 100 with the first reference voltage VREF1, a current source IS connected to a power source terminal supplied with a preset power source voltage Vdd, a first switch SW1 connected between the current source IS and a ground and performing a switching operation according to an output signal of the first detection unit 210, a capacitor C10 connected between a charging connection node NCH provided between the current source IS and the first switch. SW1 and a ground, a second detection unit 220 detecting whether or not an abnormality is present, maintained for a preset predetermined time (ΔT) by comparing a voltage VCH charged in the capacitor C10 with a preset second reference voltage VREF2, and a second switch SW2 connected between an output node No provided between an output resistor Ro connected to the power source terminal, and an output terminal OUT and the ground and performing a switching operation according to an output signal of the second detection unit 220 to output an overcurrent detection signal Sd to the output terminal OUT.

At this time, a single detection integrated circuit (IC) may be manufactured by including the first detection unit 210, the current source IS, the first switch SW1, the second detection unit 220, and the second switch SW2, except for the capacitor C10. In this case, the capacitor C10 may be connected between a charging port PCH of the detection IC and the ground.

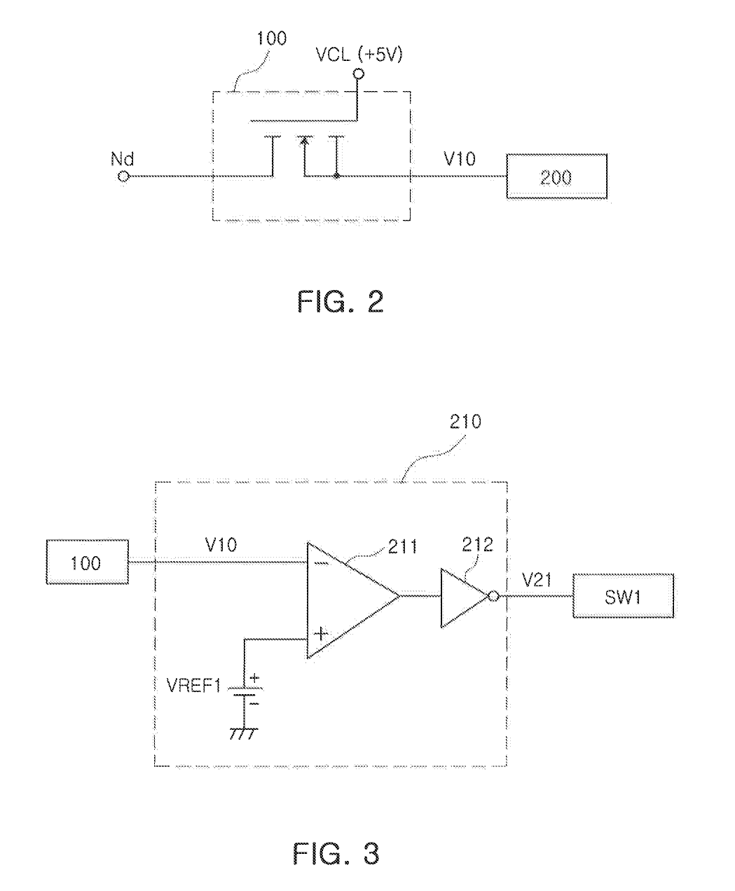

FIG. 2 shows an example of a clamping circuit unit according to the exemplary embodiment of the present invention.

Referring to FIG. 2, the clamping circuit unit 100 may include an nMOSFET including a drain connected to the detection connection node Nd, a source connected to an input terminal of the abnormality detection unit 200, and a gate connected to a clamping voltage terminal supplied with the clamping voltage VCL.

FIG. 3 shows an example of a first detecting unit according to the exemplary embodiment of the present invention.

Referring to FIG. 3, the first detection unit 210 may include a first operational amplifier 211 including an inverting input terminal receiving the voltage V10 clamped by the clamping circuit unit 100, an non-inverting input terminal receiving the first reference voltage VREF1, and an output terminal outputting a low level voltage when the clamped voltage V10 is higher than the first reference voltage VREF1 and outputting a high level voltage when the clamped voltage V10 is lower than the first reference voltage VREF1.

In addition, the first detection unit 210 may further include a first inverter 212 inverting a level of the output voltage from the first operational amplifier 211 and outputting the inverted output voltage.

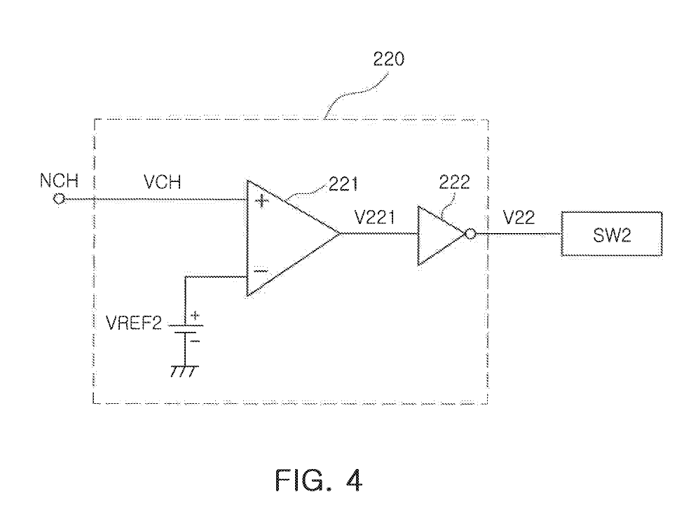

FIG. 4 shows an example of a second detecting unit according to the exemplary embodiment of the present invention.

Referring to FIG. 4, the second detection unit 220 may include a second operational amplifier 221 including a non-inverting input terminal receiving the voltage VCH charged in the capacitor C10, an inverting input terminal receiving the second reference voltage VREF2, and an output terminal outputting a low level voltage when the charged voltage VCH is lower than the second reference voltage VREF2 and outputting a high level voltage when the charged voltage VCH is higher than the second reference voltage VREF2.

The second detection unit 220 may further include a second inverter 222 inverting a level of the output voltage from the second operational amplifier 220 and outputting the inverted output voltage.

Meanwhile, the first switch SW1 may include an nMOSFET that is turned on to connect the charging connection node NCH with the ground when the output signal from the first detection unit 210 is at a high level, and is turned off to separate the charging connection node NCH from the ground when the output signal from the first detection unit 210 is at a low level.

In addition, the second switch SW2 may include an nMOSFET that is turned on to connect the output node No to the ground when the output signal from the second detection unit 220 is at a high level, and is turned off to separate the output node No from the ground when the output signal from the second detection unit 220 is at a low level.

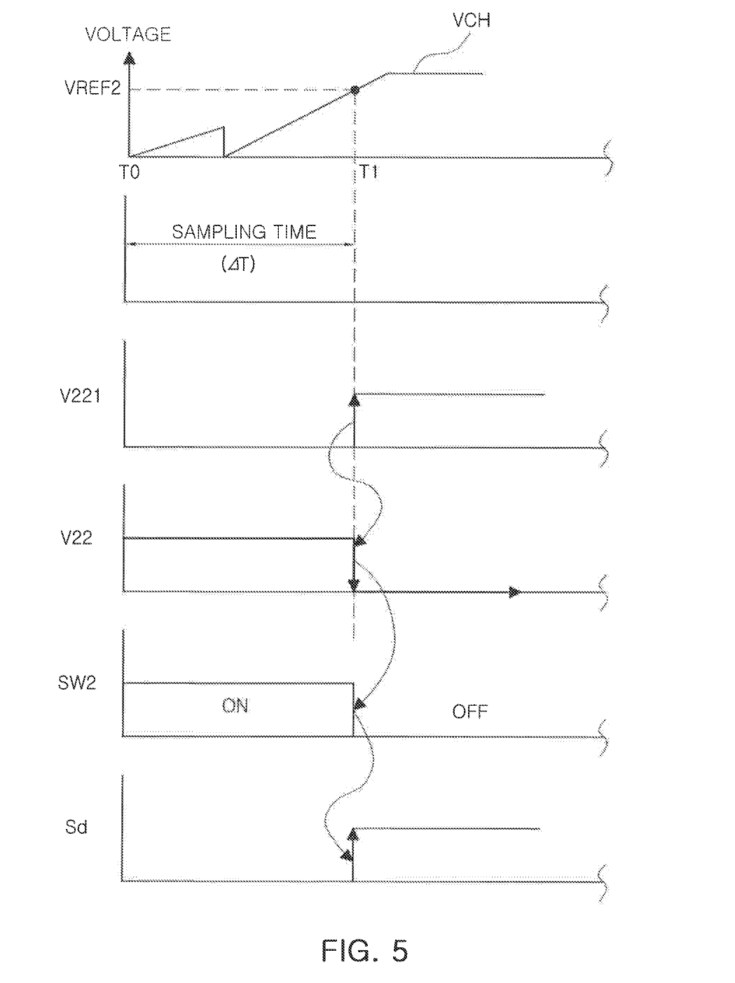

FIG. 5 is a timing chart showing main operations of the exemplary embodiment of the present invention.

Referring to FIG. 5, VCH is the voltage charged in the capacitor C10, VREF2 is the second reference voltage that is input to the inverting input terminal of the second operational amplifier 221, T0 is a time point when abnormality detection starts, T1 is a time point when the abnormality detection is determined, ΔT, that is a time from T0 to T1, is a sampling time secured for more stably detecting abnormality.

Further, V221 is the voltage outputted from the second operational amplifier 221, V22 is the voltage outputted from the second detection unit 220, SW2 is the second switch, and Sd is the overcurrent detection signal.

Hereinafter, the operations and effects of the present invention will be described in detail with reference to the accompanying drawings.

An overcurrent detection circuit of a light emitting module according to an exemplary embodiment of the present invention will be described with reference to FIGS. 1 through 5. First, referring to FIG. 1, the overcurrent detection circuit of a light, emitting module according to the exemplary embodiment of the present invention may include the clamping circuit unit 100 and the abnormality detection unit 200.

The clamping circuit unit 100 detects the detection voltage Vd from the detection connection node Nd connected to the cathode terminal NC of the light emitting module 50 including the at least one light emitting element and clamps the detection voltage Vd to the preset clamping voltage VCL.

At this time, the clamping circuit unit 100 may be connected to the detection connection node Nd between the cathode terminal NC of the light emitting module 50 and the switch 60 for controlling current flowing in the light emitting module 50. Herein, the light emitting element may be an LED.

Next, the abnormality detection unit 200 may determine the voltage V10 to be overcurrent and generate the overcurrent detection signal 3d when the voltage V10 clamped by the clamping circuit unit 100 is lower than the preset first reference voltage VREF1. In this case, the first reference voltage VREF1 may be set to have a voltage level for determining whether or not it is overcurrent.

More specifically, the clamping circuit unit 100 may output voltage having a lower level, than that of the first reference voltage to the abnormality detection unit 200 when the detection voltage Vd of the detection connection node Nd is lower than the preset clamping voltage VCL, and output the clamping voltage VCL having a higher level than that of the first reference voltage to the abnormality detection unit 200 when the detection voltage Vd of the detection connection node Nd is higher than the preset clamping voltage VCL.

An example of the abnormality detection unit 200 will be described with reference to FIG. 1.

Referring to FIG. 1, the abnormality detection unit 200 is configured to include the first detection unit 210, the current source IS, the first switch SW1, the capacitor C10, the second detection unit 220, and the second switch SW2.

First, the first detection unit 210 detects whether or not an abnormality is present by comparing the voltage V10 clamped by the clamping circuit unit 100 with the first reference voltage VREF1. Meanwhile, the current source IS may be connected to the power source terminal supplied with the preset power source voltage Vdd to generate preset current.

Next, the first switch SW1 is connected between the current source IS and the ground to perform a turn-on or turn-off switching operation according to the output signal of the first detection unit 210. In other words, when the first switch SW1 is turned on, a discharging path to the ground is formed, such that current from the current source IS flows to the ground via the discharging path. In addition, when the first switch SW1 is turned off, the discharging path to the ground may be blocked, such that the current from the current source IS is provided to the capacitor C10.

Meanwhile, when the first switch SW1 is formed of an nMOSFET, the first switch SW1 may be turned on to connect the charging connection node NCH with the ground when the output signal from the first detection unit 210 is at a high level, and may be turned off to separate the charging connection node NCH from the ground when the output signal from the first detection unit 210 is at a low level.

In addition, the capacitor C10 is connected between the charging connection node NCH provided between the current source IS and the first switch SW1 and the around. In this case, when the first switch SW1 is turned off, the capacitor C10 is charged with voltage by the current generated from the current source IS. On the other hand, when the first switch SW1 is turned on, the voltage VCH charged in the capacitor C10 is discharged by the first switch SW1.

Herein, the reason why the capacitor C10 is used will be described with reference to FIG. 5. For example, at the time point T0 when abnormality detection starts, the abnormality in which the detection voltage having a lower level than that of the first detection voltage is generated, due to short or the like, as the first switch SW1 is turned off, the capacitor C10 starts to be charged with voltage. However, when the abnormality is not detected during the abnormality detection, the switch SW1 is turned off and thus the charged voltage VCR is discharged.

In other words, in the case an abnormality is detected, when the detection of an abnormality showing an instantaneously low level of abnormal characteristics such as electrostatic discharge, noise, or the like, is not maintained for a predetermined time, it is not determined to be an abnormality detection. On the other hand, at the time point TO, when abnormality detection starts, as the first switch SW1 is turned off, the capacitor C10 starts to be charged with voltage and then the abnormality detection is maintained till the time point T1 when abnormality detection is determined, it may be determined to be an abnormality detection.

Therefore, when the capacitor is used, an instantaneous abnormal state such as electrostatic discharge, instantaneous noise or the like may be ignored, and the sampling time (ΔT) in which an abnormal state maintained for a predetermined time can be stably detected could be secured.

Next, the second detection unit 220 may detect whether or not an abnormality is present, maintained for the predetermined time (ΔT) by comparing the voltage VCH charged in the capacitor C10 with the predetermined second reference voltage VREF2.

For example, the second detection unit 220 compares the voltage VCR charged in the capacitor C10 with the preset second reference voltage VREF2. When the charged voltage VCH is higher than the second reference voltage VREF2, the second detection unit 220 may determined that the abnormality is maintained for a predetermined time (ΔT), such that it is determined to be abnormality. On the other hand, when the charging voltage VCR is not higher than the second reference voltage VREF2, the second detection unit 220 may determined that the abnormality is not maintained for a predetermined time (ΔT), such that it is not determined to be abnormality.

The second switch SW2 is connected between the output node No provided between the output resistor Ro connected to the power source terminal and the output terminal OUT and the ground and performs a switching operation according to the output signal of the second detection unit 220, thereby outputting the overcurrent detection signal Sd to the output terminal OUT.

For example, when abnormality detection is not determined in the second detection unit 220, the second switch SW2 is turned on, such that a low level signal is output to the output node No. On the other hand, when abnormality detection is determined in the second detection unit 220, the second switch SW2 is turned off, such that the overcurrent detection signal Sd having a high level may be outputted to the output node No.

As a specific example, the second switch SW2 may be formed of an nMOSFET. In this case, the nMOSFET may be turned on to connect the output node No with the ground when the output signal from the second detection unit 210 is at a high level, and may be turned off to separate the output node No from the ground when the output signal from the second detection unit 220 is at a low level.

An exemplified example of the clamping circuit unit 100 will be described with reference to FIG. 2.

A case in which the clamping circuit unit 100 is formed of an nMOSFET will be described with reference to FIG. 2. At this time, assuming that the clamping voltage VCL applied to a gate of the nMOSFET is +5V, when the detection voltage Vd detected from the detection connection node Nd is lower than +5V, the nMOSFET is turned off such that zero (0) voltage is shown in a source thereof.

On the other hand, when the detection voltage Vd detected from the detection connection node Nd is higher than +5V, the nMOSFET is turned on such that a voltage of 4.5 V, which is lower than the clamping voltage VCL by pinch-off voltage for example, 0.5 V), is supplied to a source thereof. As described above, when the detection voltage Vd is high, the voltage supplied to the source of the nMOSFET is limited to the clamping voltage VCL preset by the clamping circuit unit 100, such that high voltage is not applied to the abnormality detection unit 200, whereby an internal circuit in the abnormality detection unit 200 may be protected.

An exemplified example of the first detection unit 210 will be described with reference to FIG. 3.

Referring to FIG. 3, a case in which the first detection unit 210 includes the first operational amplifier 211 and the first inverter 212 will be described. The first operational amplifier 211 compares the voltage V10 clamped by the clamping circuit 100, inputted to the inverting input terminal thereof with the first reference voltage VREF1 inputted to the non-inverting input terminal thereof; and outputs a low level voltage when the clamped voltage V10 is higher than the first reference voltage VREF1 and outputs a high level voltage when the clamped voltage V10 is lower than the first reference voltage VREF1.

In this case, the first reference voltage VREF1 may be set to be +2.5V so that the voltage having a lower level, than that of the first reference voltage could be detected from the detection connection node Nd.

Next, the first inverter 212 inverts a level of the output voltage from the first operational amplifier 211 and outputs the inverted output voltage to the first switch SW1.

An exemplified example of the first detection unit 220 will be described with reference to FIG. 4.

A case in which the second detection unit 220 includes the second operational amplifier 221 and the second inverter 222 will be described with reference to FIG. 4. The second operational amplifier 221 receives the voltage VCH charged in the capacitor C10 through the non-inverting input terminal thereof and the second reference voltage VREF2 through the inverting input terminal thereof; and outputs a low level voltage when the charged voltage VCH is lower than the second reference voltage VREF2 and outputs a high level voltage when the charged voltage VCH is higher than the second reference voltage VREF2.

In this case, the second reference voltage VREF1 may be set to be +3.0V so that abnormality detection can be stably performed.

Next, the second inverter 222 inverts a level of the output voltage from the second operational amplifier 221 and outputs the inverted output voltage.

As described above, according to the exemplary embodiment of the present invention, the detection connection node is connected to the cathode terminal NC of the light emitting module 50, whereby an abnormal, state in which any one of the plurality of LEDs included in the LED module shorts with the chassis GND may be detected.

In addition, even during a period in which the PWM dimming of the PWM IC 70 controlling the switch 60 is turned off, ⅓ voltage of the driving voltage VLED is shown in the detection connection node Nd due to LED leakage and, for example, in a case in which the driving voltage VLED is 100V, voltage of approximately 33 V is shown in the detection connection node, whereby a normal protection may be performed.

In other words, the detection connection node is connected to the cathode terminal NC of the light emitting module 50 as described above, whereby the protection function of the LED module may be performed under all conditions on the TV set, irrespective of the PWM mode.

As set forth above, according to exemplary embodiments of the present invention, the overcurrent may be detected in both a turn-on state of the PWM and a turn-off state thereof in the light emitting module that may be applied to a television or a display, the overcurrent caused by an abnormal operation such as circuit board and chassis shorts or the like.

Therefore, in the LED driving power circuit, LED overcurrent may be prevented when the LED shorts with the chassis GND.

In addition, the exemplary embodiment of the present invention may apply the clamp function, whereby detection circuit and elements may be protected from the overcurrent, manufacturing costs of the protection circuit unit may be reduced as compared to the related art, and the ability or protecting and detecting overcurrent may be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. An overcurrent detection circuit of a light emitting module, the overcurrent detection circuit comprising:
a clamping circuit unit detecting a detection voltage from a detection connection node connected to a cathode terminal of a light emitting module including at least one light emitting element and clamping the detection voltage to a preset clamping voltage; and
an abnormality detection unit determining the voltage clamped by the clamping circuit unit to be overcurrent and generating an overcurrent detection signal when the voltage clamped by the clamping circuit unit is lower than a preset first reference voltage.

2. The overcurrent detection circuit of claim 1, wherein the clamping circuit unit is connected to the detection connection node between the cathode terminal of the light emitting module and a switch for controlling current flowing in the light emitting module.

3. The overcurrent detection circuit of claim 2, wherein the clamping circuit unit outputs voltage having a lower level than that of the first reference voltage to the abnormality detection unit when the detection voltage of the detection connection node is lower than the preset clamping voltage, and outputs the clamping voltage having a higher level than the first reference voltage to the abnormality detection unit when the detection voltage of the detection connection node is higher than the preset clamping voltage.

4. The overcurrent detection circuit of claim 3, wherein the abnormality detection unit includes:
a first detection unit detecting whether or not an abnormality is present by comparing the voltage clamped by the clamping circuit unit with the first reference voltage;
a current source connected to a power source terminal supplied, with preset power source voltage;
a first switch connected between the current source and a ground and performing a switching operation according to an output signal of the first detection unit;
a capacitor connected between a charging connection node provided between the current source and the first switch and the ground;
a second detection unit detecting whether or not an abnormality is present, maintained for a preset predetermined time by comparing the voltage charged in the capacitor with a preset second reference voltage; and
a second switch connected between an output node provided between an output resistor connected to the power source terminal and an output terminal and the ground and performing a switching operation according to an output signal of the second detection unit to output an overcurrent detection signal to the output terminal.

5. The overcurrent detection circuit of claim 3, wherein the clamping circuit unit includes an nMOSFET including a drain connected to the detection connection node, a source connected to an input terminal of the abnormality detection unit, and a gate connected to a clamping voltage terminal supplied with the clamping voltage.

6. The overcurrent detection circuit of claim 4, wherein the first detection unit includes a first operational amplifier including an inverting input terminal receiving the voltage clamped by the clamping circuit unit, an non-inverting input terminal receiving the first reference voltage, and an output terminal outputting a low level voltage when the clamped voltage is higher than the first reference voltage and outputting a high level voltage when the clamped voltage is lower than the first reference voltage.

7. The overcurrent detection circuit of claim 6, wherein the first detection unit further includes a first inverter inverting a level of the output voltage from the first operational amplifier and outputting the inverted output voltage.

8. The overcurrent detection circuit of claim 6, wherein the second detection unit includes a second operational amplifier including a non-inverting input terminal receiving the voltage charged in the capacitor, an inverting input terminal receiving the second reference voltage, and an output terminal outputting the low level voltage when the charged voltage is lower than the second reference voltage and outputting the high level voltage when the charged voltage is higher than the second reference voltage.

9. The overcurrent detection circuit of claim 8, wherein the second detection unit further includes a second inverter inverting a level of the output voltage from the second operational amplifier and outputting the inverted output voltage.

10. The overcurrent detection circuit of claim 4, wherein the first switch includes an nMOSFET that is turned on to connect the charging connection node with the ground when the output signal of the first detection unit is at a high level, and is turned off to separate the charging connection node from the ground when the output signal of the first detection unit is at a low level.

11. The overcurrent detection circuit of claim 4, wherein the second switch includes an nMOSFET that is turned on to connect the output node with the ground when the output signal of the second detection unit is at a high level, and is turned off to separate the output node from the ground when the output signal of the second detection unit is at a low level.
